(19) United States
(12) Patent Application Publication
(10) Pub. No.: US 2012/0162177 A1
(43) Pub. Date: Jun. 28, 2012

(54) PIXEL AND ORGANIC LIGHT EMITTING DISPLAY DEVICE USING THE SAME

(75) Inventor: Dong-Beom Lee, Yongin-city (KR)

(73) Assignee: Samsung Mobile Display Co., Ltd., Yongin-city (KR)

(21) Appl. No.: 13/227,248

(22) Filed: Sep. 7, 2011

(30) Foreign Application Priority Data
Dec. 23, 2010 (KR) 10-2010-0133888

(51) Int. Cl. G09G 5/00

(52) U.S. Cl. 345/211; 345/76

(57) ABSTRACT

A pixel and an organic light emitting diode (OLED) display using the same are disclosed. The pixel comprises an organic light emitting diode (OLED), a first transistor transmitting a driving current to the OLED according to a data signal, a second transistor controlling light emission of the OLED in response to a light emission control signal, a third transistor initializing a gate voltage of the first transistor in response to an initialization signal, a fourth transistor transmitting the data signal to the gate of the first transistor, and a storage capacitor connected to the gate of the first transistor, the first transistor, and the second transistor.

### CROSS-REFERENCE TO RELATED APPLICATION

This application claims priority to and the benefit of Korean Patent Application No. 10-2010-0133888 filed in the Korean Intellectual Property Office on Dec. 23, 2010, the entire contents of which are incorporated herein by reference.

### BACKGROUND

1. Field

The disclosed technology relates to a pixel and an organic light emitting diode (OLED) display using the same, and more particularly relates to a pixel including a diode-connected transistor which compensates for threshold voltage in a driving transistor and compensates a deviation of the driving transistor, to an organic light emitting display panel, and to an organic light emitting diode (OLED) display using the same.

2. Description of the Related Technology

Various flat panel displays having reduced weight and volume when compared to a cathode ray tube have been developed. Flat panel displays include liquid crystal displays (LCD), field emission displays (FED), plasma display panels (PDP), organic light emitting diode (OLED) displays, and the like.

Of the flat panel displays, the organic light emitting diode display, which displays images by using in each pixel an organic light emitting diode (OLED) that generates light by recombining electrons and holes, has a fast response speed, is driven with low power consumption, and has excellent emission efficiency, luminance, and viewing angle, such that it has recently been favored.

In general, each pixel of the organic light emitting diode (OLED) display includes an organic light emitting diode (OLED), a driving transistor controlling a current to drive the organic light emitting diode (OLED), a switching transistor applying a data signal to the driving transistor for expression of grayscales, and a capacitor for storing the data signal. The pixels use a current driving method, and important characteristics of the driving transistor determining driving current of the driving transistor include a threshold voltage and electron mobility of the driving transistor.

Recently, as display device are becoming larger and are produced through an automation process, the threshold voltage of the driving transistor included in each pixel of the display device is affected by a distribution process and it is difficult to ensure uniformity of characteristics between the driving transistors. To address the driving current distribution problem of the organic light emitting diode (OLED), in addition to improving the characteristic deviation between the driving transistors, compensation for the threshold voltage of the driving transistor has been used.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

One inventive aspect is a pixel. The pixel includes an organic light emitting diode (OLED), a first transistor configured to transmit a driving current to the organic light emitting diode (OLED) according to a data signal, a second transistor configured to control light emission of the organic light emitting diode (OLED) in response to a light emission control signal, and a third transistor configured to transmit an initialization voltage to a gate of the first transistor in response to an initialization signal. The pixel also includes a fourth transistor configured to transmit the data signal to the gate of the first transistor, and a storage capacitor connected to the gate of the first transistor, to the first transistor, and to the second transistor.

Another inventive aspect is an organic light emitting diode (OLED) display. The display includes a light emission driver configured to transmit a plurality of light emission control signals to a plurality of light emission control lines, an initialization driver configured to transmit a plurality of initialization signals to a plurality of initialization control lines, a data driver configured to transmit a plurality of data signals to a plurality of data lines, and a controller configured to control the light emission driver, the initialization driver, and the data driver and to generate a data signal corresponding to a video signal and supply the data signal to the data driver. The display also includes a display unit with a plurality of pixels each connected to one of the light emission control lines, one of the initialization control lines, and one of the data lines, where the display unit is configured to display an image by emitting light according to the data signal. The pixels respectively include a driving transistor receiving data signals transmitted through the corresponding data line after being initialized with the initialization voltage in response to the initialization signal transmitted through the corresponding initialization control line, and an organic light emitting diode (OLED) emitting light based on a driving current from the driving transistor, the driving current being based on the data signal.

### BRIEF DESCRIPTION OF THE DRAWINGS

FIG. 1 is a block diagram of an organic light emitting diode (OLED) display according to an exemplary embodiment.

FIG. 2 is a circuit diagram of an exemplary embodiment of the pixel shown in FIG. 1.

FIG. 3 is a driving waveform diagram of a driving method of the pixel shown in FIG. 2.

### DETAILED DESCRIPTION OF CERTAIN INVENTIVE EMBODIMENTS

Certain features and aspects are described more fully hereinafter with reference to the accompanying drawings, in which exemplary embodiments are shown. As those skilled in the art would realize, the described embodiments may be modified in various ways, without departing from the spirit or scope of the present invention.

Constituent elements having the same structures throughout the embodiments are generally denoted by the same reference numerals and are described in a first embodiment. In some cases, in subsequent embodiments, only new constituent elements may be described. In addition, parts not related to the description may be omitted for clarity.

Throughout this specification and the claims that follow, when it is described that an element is “coupled” to another element, the element may, for example, be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

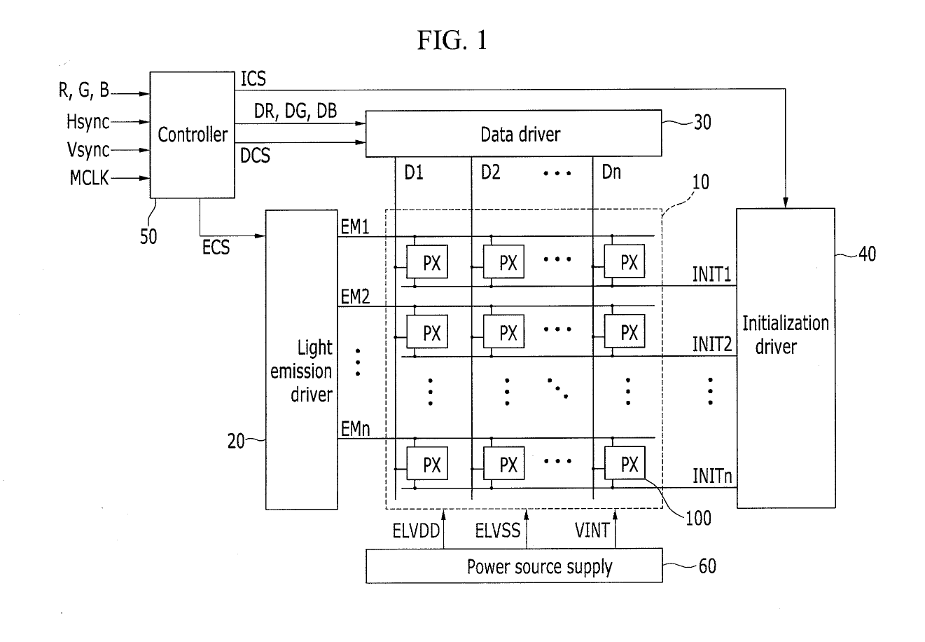

FIG. 1 is a block diagram of an organic light emitting diode (OLED) display according to an exemplary embodiment.

The organic light emitting diode (OLED) display of FIG. 1 includes a display unit 10 including a plurality of pixels, a light emission driver 20, a data driver 30, an initialization driver 40, a controller 50, and a power source supply 60 supplying an external voltage.

The plurality of pixels are respectively connected to a corresponding light emission control line of a plurality of light emission control lines EM1 to EMn, a corresponding data line of a plurality of data lines D1 to Dm, and a corresponding initialization control line of a plurality of initialization control lines INIT1 to INITn. The light emission control lines EM1 to EMn, the plurality of data lines D1 to Dm, and the plurality of initialization control lines INIT1 to INITn respectively cover the display unit 10. Also, the plurality of pixels are respectively connected to a power supply line connected to the display unit 10 and receive a first power source voltage ELVDD, a second power source voltage ELVSS, and an initialization voltage VINT from the outside.

The display unit 10 includes a plurality of pixels arranged in an approximate matrix format. While not being limited thereto, a plurality of light emission control lines EM1 to EMn and a plurality of initialization control lines INIT1 to INITn are arranged in a row direction and are in parallel with each other in the arranged form of the pixels, and a plurality of data lines D1 to Dm are arranged in a column direction and are parallel with each other.

A plurality of pixels respectively emit light of a predetermined luminance according to a driving current supplied to the organic light emitting diode (OLED) based on a data signal transmitted through a plurality of data lines D1 to Dm.

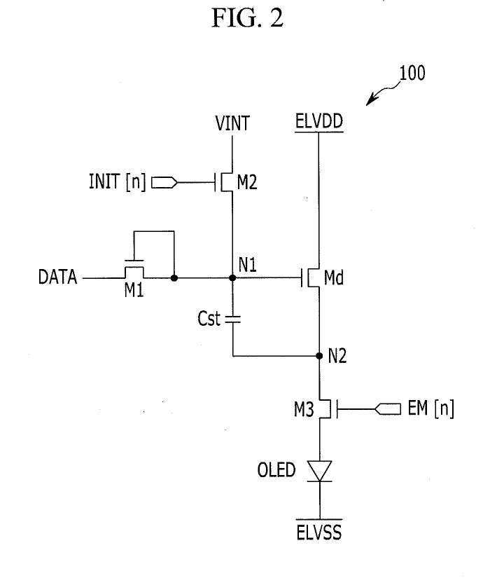

The pixels respectively include a plurality of transistors formed as PMOS type or NMOS type. Here, the first power source voltage ELVDD respectively supplied to the pixels is a higher voltage than the second power source voltage ELVSS to supply the current to the organic light emitting diode OLED included in each pixel for the light emission. A circuit structure of a pixel according to an exemplary embodiment of the present invention will be described in detail with reference to FIG. 2.

The light emission driver 20 generates and transmits a light emission control signal to each pixel through a plurality of light emission control lines EM1 to EMn. That is, the light emission driver 20 transmits the light emission control signal to a plurality of pixels included in each pixel line through the corresponding light emission control line. The light emission driver 20 receives the light emitting driving control signal ECS from the controller 50 to generate the plurality of light emission control signals and to sequentially supply the light emission control signal to a plurality of light emission control lines EM1 to EMn connected to each pixel line.

The data driver 30 transmits the data signal to each pixel through a plurality of data lines D1 to Dm. The data driver 30 receives the data driving control signal DCS from the controller 50 to supply the corresponding data signal to the data lines D1 to Dm connected to the pixels included in each pixel line.

The initialization driver 40 generates and transmits the initialization signal to each pixel through a plurality of initialization control lines INIT1 to INITn. That is, the initialization driver 40 transmits the initialization signal to the pixels of each pixel line through the corresponding initialization control line. The initialization driver 40 receives the initialization driving control signal ICS from the controller 50 to generate a plurality of initialization signals and to sequentially supply the initialization signals to the plurality of initialization control lines INIT1 to INITn connected to each pixel line.

According to an exemplary embodiment, the initialization signal may be a voltage turning on the transistors included in the pixel, and the light emission control signal may be a voltage turning off the transistors.

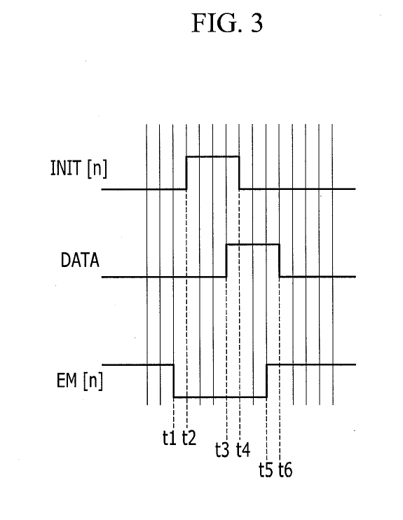

The voltage turning on or turning off the transistors is changed according to the type (PMOS or NMOS) of the transistors included in the pixel. Referring to FIG. 2 and FIG. 3, a pixel according to an exemplary embodiment includes NMOS transistors, and accordingly, the voltage turning on the transistors is the high level voltage, and the voltage turning them off is the low level voltage. Accordingly, the initialization signal may be the high level voltage and the light emission control signal may be set as the low level voltage. In another exemplary embodiment including PMOS transistors, the predetermined voltage of the signal is opposite thereto.

Also, the plurality of light emission control signals in an exemplary embodiment are set with a wider pulse width than the initialization signals, and the light emission control signal and the initialization signal supplied through the light emission control line and the initialization control line connected to the same pixel line may be overlapped.

The controller 50 changes a plurality of video signals R, G, and B transmitted from the outside into a plurality of image data signals DR, DG, and DB and transmits them to the data driver 30. The controller 50 receives a vertical synchronization signal Vsync, a horizontal synchronization signal Hsync, and a clock signal MCLK to generate and transmit the control signals to control the driving of the light emission driver 20, the data driver 30, and the initialization driver 40. That is, the controller 50 generates and transmits a light emitting driving control signal ECS controlling the light emission driver 20, a data driving control signal DCS controlling the data driver 30, and an initialization driving control signal ICS controlling the initialization driver 40.

The power source supply 60 supplies the first power source voltage ELVDD, the second power source voltage ELVSS, and the initialization voltage VINT to each pixel of the display unit 10. The first power source voltage ELVDD has a higher voltage level than the second power source voltage ELVSS. Also, the initialization voltage VINT may be a higher voltage than the voltage level of the data signals.

FIG. 2 is a circuit diagram of an exemplary embodiment of the pixel shown in FIG. 1, and FIG. 3 is a driving waveform diagram of a driving method for the pixel shown in FIG. 2. For better comprehension and ease of description for FIG. 2 and FIG. 3, the pixel is a pixel 100 positioned at the n-th pixel line among the plurality of pixel lines and the m-th pixel column among a plurality of pixels of the display unit 10. Accordingly, the pixel 100 is connected to the n-th light emission control line EMn and the n-th initialization control line INITn, and the m-th data line Dm.

Referring to FIG. 2, the pixel 100 according to an exemplary embodiment includes four transistors Md, M1, M2, and M3, one storage capacitor Cst, and an organic light emitting diode OLED.

The pixel 100 includes a driving transistor Md supplying a driving current to the organic light emitting diode OLED corresponding to the data voltage according to the data signal input to the gate, the organic light emitting diode OLED emitting light in response to receiving the driving current, a switching transistor M1 switching the data signal DATA transmitted to the m-th data line among the plurality of data lines, an initialization transistor M2 applying the initialization voltage VINT to the gate of the driving transistor Md, a light emission control transistor M3 positioned between the driving transistor Md and the anode of the organic light emitting diode OLED and controlling the light emission of the organic light emitting diode OLED by blocking the driving current during a predetermined time, and a storage capacitor Cst having two terminals connected between the gate and the source of the driving transistor Md and maintaining the gate electrode voltage of the driving transistor Md during the predetermined period.

The gate electrode of the driving transistor Md is connected to the first node N1, the drain electrode is connected to the supplying line of the first power source voltage ELVDD, and the source electrode is connected to the second node N2. The driving transistor Md controls the current amount passing through the organic light emitting diode OLED from the first power source voltage ELVDD corresponding to the voltage applied to the first node N1 and flowing in the supplying line of the second power source voltage ELVSS.

The gate electrode and the drain electrode of the switching transistor M1 are connected to the first node N1, and the source electrode is connected to the m-th data line transmitting the predetermined data signal DATA. That is, the switching transistor M1 is diode-connected such that the current flows in the direction from the first node N1 to the source electrode of the switching transistor M1 connected to the m-th data line. The switching transistor M1 may be realized to have the same characteristic as the driving transistor Md to compensate the threshold voltage of the driving transistor Md, that is, the threshold voltage.

The gate electrode of the initialization transistor M2 is connected to the n-th initialization control line to receive the n-th initialization signal INIT[n] and the drain electrode is connected to the supply line of the initialization voltage VINT, and the source electrode is connected to the first node N1. Therefore, when the initialization transistor M2 is turned on in response to the n-th initialization signal INIT[n], the initialization voltage VINT is applied to the first node N1.

The gate electrode of the light emission control transistor M3 is connected to the n-th light emission control line to receive the n-th light emission control signal EM[n], the drain electrode is connected to the second node N2, and the source electrode is connected to the anode of the organic light emitting diode OLED. Therefore, when the light emission control transistor M3 is turned off in response to the n-th light emission control signal EM[n], the driving current corresponding to the data voltage according to the data signal being supplied to the organic light emitting diode OLED is blocked. On the other hand, if the n-th light emission control signal EM[n] is transmitted as the on voltage level, the light emission control transistor M3 is turned on such that the driving current according to the data voltage flows from the driving transistor Md connected to the second node N2 to the organic light emitting diode OLED.

The anode of the organic light emitting diode OLED is connected to the source electrode of the light emission control transistor M3, and the cathode is connected to the supply line of the second power source voltage ELVSS. The organic light emitting diode OLED emits light of a luminance corresponding to the driving current for the display of the image.

The storage capacitor Cst is connected between the first node N1 (i.e., the gate electrode of the driving transistor) and the second node N2 (i.e., the driving transistor and the shared node of the light emission control transistor). Accordingly, the storage capacitor Cst stores the voltage difference between the voltages applied to two electrodes during the predetermined period.

The driving method of the pixel shown in FIG. 2 is described with reference to the driving waveform diagram of FIG. 3.

At the time t1, the n-th light emission control signal EM[n] is supplied through the light emission control line EMn connected to the n-th pixel line such that the light emission control transistor M3 is turned off. That is, the n-th light emission control signal EM[n] is transmitted as the low level voltage such that the light emission control transistor M3 as an NMOS transistor is turned off. At this time, each light emission control transistor of the plurality of pixels included in the n-th pixel line is turned off.

At the time t2, the n-th initialization signal INIT[n] is supplied through the initialization control line INITn connected to the n-th pixel line such that the initialization transistor M2 is turned on. That is, the n-th initialization signal INIT[n] is transmitted as the high level voltage such that the initialization transistor M2 as an NMOS transistor is turned on. Thus, the initialization voltage VINT is applied to the first node N1 through the channel between the drain and source of the initialization transistor M2. The initialization voltage VINT applied to the first node N1 has a higher voltage level than the data voltage range of the data signal.

Next, at the time t3, the data signal DATA is transmitted through the m-th data line Dm connected to the source electrode of the switching transistor M1 such that the data voltage VDATA according thereto is switched. In other words, the voltage supplied to the first node N1 is applied after passing through the diode-connected switching transistor M1, and thereby the voltage of the first node N1 is set as the voltage VDATA+VthM1 that is the threshold voltage of the switching transistor M1 added to the predetermined data voltage VDATA.

After the time t3, the voltage applied to the first node N1 is maintained by the storage capacitor Cst. In response to the voltage applied to the first node N1 current flows from the driving transistor Md to the organic light emitting diode OLED.

The initialization signal INIT[n] is transmitted as a low level at the time t4 such that the initialization transistor M2 is turned off. When the initialization transistor M2 is turned off, the initialization voltage VINT is not supplied. Therefore, a response period of initialization signal INIT[n], that is, the high level period of initialization signal INIT[n] during which the initialization transistor M2 is turned on, is provided before the data voltage VDATA is transmitted.

In other words, the initialization process is independently and sequentially progresses for the pixel line, and then the data writing process is executed. Accordingly, the time t4 that the initialization transistor M2 is turned off may overlap or be synchronized with the time t3 that the data voltage VDATA is transmitted, or may be before the time t3.

At the time t5, the n-th light emission control signal EM[n] is supplied through the light emission control line EMn connected to the n-th pixel line such that the light emission control transistor M3 is turned on. That is, the n-th light emission control signal EM[n] is transmitted as the high level voltage such that the light emission control transistor M3 as an NMOS transistor is turned on. Thus, the driving current corresponding to the voltage of the first node N1 maintained by the storage capacitor Cst through the light emission control transistor M3 is supplied to the organic light emitting diode OLED.

The gate electrode of the driving transistor Md connected to the first node N1 is set as the high voltage of the voltage VDATA+VthM1 such that the driving transistor Md is turned on, and the predetermined driving current may be supplied according to the turn on of the light emission control signal EM[n].

In this case, the second node N2 is applied with the voltage ELVSS+VOLED of which the parasitic capacitor voltage VOLED of the organic light emitting diode OLED is added to the second power source voltage ELVSS. Accordingly, the voltage of the second node N2 is decreased from the source electrode voltage VS of the driving transistor Md connected to the second node N2 to the voltage ELVSS+VOLED.

Here, the change amount of the voltage of the second node N2 voltage is represented as Equation 1.

ΔV=VS−(ELVSS+VOLED) [Equation 1]

If the voltage of the second node N2 is changed as in Equation 1, the voltage of the first node N1 is changed effectively as in Equation 2 by the coupling of the storage capacitor Cst connected thereto.

Vn1=VDATA+VthM1−ΔV [Equation 2]

Thus, the voltage between the gate electrode and the source electrode of the driving transistor Md is determined as in Equation 3.

$$\begin{matrix}Vgs = ( VDATA + VthM 1 - Δ V ) - ( ELVSS + VOLED ) \\ = VDATA + VthM 1 - VS\end{matrix} \qquad [ Equation 3 ]$$

In this embodiment, the driving current I flowing from the driving transistor Md to the organic light emitting diode OLED flows as in Equation 4.

$$\begin{matrix}I = β \times {( Vgs - VthMd )}^{2} \\ = β \times {( VDATA + VthM 1 - VS - VthMd )}^{2} \\ = β \times {( VDATA - VS )}^{2}\end{matrix} \qquad [ Equation 4 ]$$

In Equation 4, β is a constant value, and VthMd is the threshold voltage of the driving transistor Md. The threshold voltage VthM1 of the switching transistor M1 and the threshold voltage VthMd of the driving transistor Md are realized as the same such that the factor of the threshold voltage of the driving transistor Md is removed as in Equation 4.

Referring to Equation 4, the driving current according to the data signal flowing into the organic light emitting diode OLED is determined by the data voltage VDATA and the source electrode voltage VS of the driving transistor Md. Accordingly, the deviation of the threshold voltage of each driving transistor Md of the plurality of pixels of the display unit 10 may be compensated.

Next, the transmission of the data signals DATA is stopped at the time t6. In other words, the data voltage VDATA is decreased to be less than the predetermined level at the time t6. Thus, the current path of the forward direction due to the diode-connection of the switching transistor M1 is not formed such that the organic light emitting diode OLED may emit the light with the driving current of Equation 4 during the corresponding frame.

In the following frame, the process of FIG. 3 is repeated, and thereby the light emission control signal EM[n] is transmitted as the low level such that the initialization voltage VINT is applied to the first node N1 after the light emission control transistor M3 is turned off. Thus, the data information written to the gate of each driving transistor Md of the plurality of pixels is initialized such that the data signal corresponding to the new frame may be written.

According to an exemplary embodiment, the transistors configuring the pixel are realized as NMOS transistors, and the first power source voltage ELVDD of 12V, the second power source voltage ELVSS of 0V, the initialization voltage VINT of 20V, and the data voltage of the range of 10V to 15V may be set. However, the type of the transistor and the voltage values may be varied, and it is not limited to the above-described exemplary embodiment. However, in some embodiments, the initialization voltage is higher than the data voltage range.

Although various aspects are described with reference to the detailed exemplary embodiments, this is by way of example only and the present invention is not limited thereto. A person of ordinary skill in the art may change or modify the described exemplary embodiments without departing from the scope of the present invention, and changes or modifications are also included in the scope of the present invention. Further, materials of each component described in the present specification are selected from or replaced by various materials known to a person of ordinary skill in the art. In addition, a person of ordinary skill in the art may omit some of the components described in the present specification without deteriorating the performance or add components in order to improve the performance. Further, a person of ordinary skill in the art may change a sequence of processes described in the present specification according to the process environments or equipment.

What is claimed is:

1. A pixel comprising:
an organic light emitting diode (OLED);
a first transistor configured to transmit a driving current to the organic light emitting diode (OLED) according to a data signal;
a second transistor configured to control light emission of the organic light emitting diode (OLED) in response to a light emission control signal;
a third transistor configured to transmit an initialization voltage to a gate of the first transistor in response to an initialization signal;
a fourth transistor configured to transmit the data signal to the gate of the first transistor; and
a storage capacitor connected to the gate of the first transistor, to the first transistor, and to the second transistor.

2. The pixel of claim 1, wherein the fourth transistor is positioned between a data line transmitting the data signal and the first transistor, and is diode-connected for current to flow from the first transistor to the data line.

3. The pixel of claim 1, wherein the fourth transistor transmits the data signal as the voltage on a data line increased by the threshold voltage of the fourth transistor.

4. The pixel of claim 1, wherein the threshold voltage of the fourth transistor is substantially the same as the threshold voltage of the first transistor.

5. The pixel of claim 1, wherein the initialization voltage is higher than a maximum voltage of the data signal.

6. The pixel of claim 1, wherein the first to fourth transistors are NMOS transistors.

7. The pixel of claim 6, wherein the first transistor includes:
a gate connected to the third transistor, the fourth transistor, and the storage capacitor;
a drain connected to a supply line supplying the first power source voltage; and
a source connected to the first common node.

8. The pixel of claim 6, wherein the second transistor includes:
a gate connected to a light emission control line transmitting a light emission control signal;
a drain connected to the first common node; and
a source connected to the anode of the organic light emitting diode (OLED).

9. The pixel of claim 6, wherein the third transistor includes:
a gate connected to an initialization control line transmitting the initialization signal;
a drain connected to a supply line applying the initialization voltage; and
a source connected to the first transistor, the fourth transistor, and the storage capacitor.

10. The pixel of claim 6, wherein the fourth transistor includes:
a gate and drain each connected to the first transistor, the third transistor, and the storage capacitor; and
a source connected to a data line transmitting the data signal.

11. The pixel of claim 1, wherein the storage capacitor includes:
one electrode connected to the first and second transistors; and
another electrode connected to the first transistor, the third transistor, and the fourth transistor.

12. An organic light emitting diode (OLED) display comprising:
a light emission driver configured to transmit a plurality of light emission control signals to a plurality of light emission control lines;
an initialization driver configured to transmit a plurality of initialization signals to a plurality of initialization control lines;
a data driver configured to transmit a plurality of data signals to a plurality of data lines;
a controller configured to control the light emission driver, the initialization driver, and the data driver and to generate a data signal corresponding to a video signal and supply the data signal to the data driver; and
a display unit including a plurality of pixels each connected to one of the light emission control lines, one of the initialization control lines, and one of the data lines, wherein the display unit is configured to display an image by emitting light according to the data signal,
wherein the plurality of pixels respectively include:
a driving transistor receiving data signals transmitted through the corresponding data line after being initialized with the initialization voltage in response to the initialization signal transmitted through the corresponding initialization control line; and
an organic light emitting diode (OLED) emitting light based on a driving current from the driving transistor, the driving current being based on the data signal.

13. The organic light emitting diode (OLED) display of claim 12, wherein the plurality of pixels respectively further include an initialization transistor transmitting the initialization voltage to the gate of the driving transistor in response to the initialization signal.

14. The organic light emitting diode (OLED) display of claim 12, wherein the plurality of pixels respectively further include a switching transistor positioned between the corresponding data line and the driving transistor, the switching transistor configured to transmit the data signal to the gate of the driving transistor.

15. The organic light emitting diode (OLED) display of claim 14, wherein the switching transistor is diode-connected for a current from the driving transistor to the data line.

16. The organic light emitting diode (OLED) display of claim 14, wherein the switching transistor transmits the data signal as the voltage on a data line increased by the threshold voltage of the fourth transistor.

17. The organic light emitting diode (OLED) display of claim 16, wherein the threshold voltage of the switching transistor is substantially the same as the threshold voltage of the driving transistor.

18. The organic light emitting diode (OLED) display of claim 16, wherein when the driving transistor transmits the driving current to the organic light emitting diode (OLED), the driving current is substantially independent of the threshold of the driving transistor.

19. The organic light emitting diode (OLED) display of claim 12, wherein the plurality of pixels respectively include:
a light emission control transistor positioned between the driving transistor and the organic light emitting diode (OLED), wherein the light emission control transistor is configured to control the flow of current from the driving transistor in response to the light emission control signal transmitted through the corresponding light emission control line.

20. The organic light emitting diode (OLED) display of claim 12, wherein the initialization voltage is higher than a maximum voltage of the data signal.

21. The organic light emitting diode (OLED) display of claim 12, wherein the transistors forming the plurality of pixels are PMOS transistors or NMOS transistors.

22. The organic light emitting diode (OLED) display of claim 12, wherein the plurality of light emission control signals and the plurality of initialization signals are sequentially transmitted to pixel lines of the display unit.

23. The organic light emitting diode (OLED) display of claim 12, wherein the gate off voltage level duration of the light emission control signal is longer than the gate on voltage level duration of the initialization signal.

24. The organic light emitting diode (OLED) display of claim 23, wherein the light emission control signal overlaps the initialization signal.
